(19) United States
(12) Patent Application Publication
(10) Pub. No.: US 2008/0211513 A1
(43) Pub. Date: Sep. 4, 2008

(54) INITIATION OF FUSE SENSING CIRCUITRY AND STORAGE OF SENSED FUSE STATUS INFORMATION

(75) Inventors: Mark A. Lysinger, Carrollton, TX (US); Naren Sahoo, Carrollton, TX (US)

Correspondence Address: STMICROELECTRONICS, INC., MAIL STATION 2346, 1310 ELECTRONICS DRIVE, CARROLLTON, TX, 75006, US

(73) Assignee: STMicroelectronics, Inc., Carrollton, TX (US)

(21) Appl. No.: 12/028,504

(22) Filed: Feb. 8, 2008

Related U.S. Application Data
(60) Provisional application No. 60/901,370, filed on Feb. 15, 2007.

(51) Int. Cl. H01H 85/30

(52) U.S. Cl. 324/550

(57) ABSTRACT

An integrated circuit includes at least one circuit trimming fuse. A fuse sensor circuit is connected to the trimming fuse and operates in response to a fuse sensing initiation signal to initiate sensing of a state of the trimming fuse and generate an output indicative of the sensed state. A latch circuit, including multiple latch locations, redundantly latches the output indicative of the sensed state. A majority logic state in the latch locations is determined by a polling circuit coupled to the multiple latch locations. The polling circuit outputs that majority logic state as a fuse state output indicative of the sensed state of the fuse. A register in the integrated circuit is loadable with a value. A comparison circuit compares the loaded value in the register to a correct fuseword value and, if there is a match, generates the fuse sensing initiation signal for application to the fuse sensor circuit.

### PRIORITY CLAIM

The present application claims the benefit of U.S. Provisional Application for Patent Ser. No. 60/901,370 filed Feb. 15, 2007, the disclosure of which is hereby incorporated by reference.

### BACKGROUND OF THE INVENTION

1. Technical Field of the Invention

The present invention relates to integrated circuits whose operational parameters are capable of being trimmed post-fabrication using fuse circuitry and, in particular, to circuitry for sensing the state of fuses and latching the sensed fuse state.

2. Description of Related Art

Currently manufactured integrated circuits typically have a post-fabrication adjustment capability using some method of circuit trimming. In many circuits, this adjustment capability uses an off/on selection technique to make the desired trimming adjustments. Fuse structures are often used for the apparatus to implement the off/on selection technique. These fuse structures include a thin conductor of poly-silicon or metal. When the conductor is in place, the off/on selection for circuit trimming is in one state (for example, “off”). The fuse structure, however, can be “blown” by running a high current through the conductor or by blasting the conductor with a laser. When the conductor is blown and is no longer in place, the off/on selection for circuit trimming is in another state (for example, “on”). As an example, the off/on selection of each one of a plurality of fuses can be used in an integrated circuit to trim circuit operations such as: a supply voltage level, filter operation, or oscillator frequency. Other trimming applications, or uses for trimming fuses, are well known to those skilled in the art.

The thin conductor of the fuse structure is usually connected to a circuit which is functionally operable to sense whether the conductor is intact or has been blown. Modern fuse sensing circuits are typically initiated for operation only during power-up in order to minimize power consumption. This initiation for fuse sensing operation is usually controlled responsive to an onboard power-on-reset (POR) circuit that provides a one-time clock signal to start the fuse sensor circuit. The output of the fuse sensor circuit can be monitored in order to provide feedback confirming fuse status (i.e., the presence or absence of the fuse). In this way, the person trimming the integrated circuit can confirm that the desired trimming operations have been successfully completed.

These fuse sensor circuits, however, draw sufficient enough power to make them problematic for very low power consumption applications such as when the integrated circuit is powered from a battery. A need accordingly exists in the art for a fuse sensing technique that can sense and provide output concerning fuse state, but consumes very little power. It would be preferred if greater control could be exercised over when fuse sensing was performed.

### SUMMARY

In an embodiment, a circuit comprises: a trimming fuse and a fuse sensor circuit connected to the trimming fuse which operates in response to a fuse sensing initiation signal to initiate sensing of a state of the trimming fuse and generate an output indicative of the sensed state. A data register is loadable with a value. A comparison circuit compares the loaded value in the register to a correct fuseword value and, if there is a match, generates the fuse sensing initiation signal for application to the fuse sensor circuit.

In an embodiment, a method comprises: comparing a loaded fuseword value to a correct fuseword value; if there is a match, generating a fuse sensing initiation signal; and performing a fuse sensing operation in response to the generated fuse sensing initiation signal to sense a state of a trimming fuse and generate an output indicative of the sensed state.

In an embodiment, a circuit comprises: a trimming fuse and a fuse sensor circuit connected to the trimming fuse which operates in response to a fuse sensing initiation signal to initiate sensing of a state of the trimming fuse and generate an output indicative of the sensed state. A register is loadable with a value. A first comparison circuit compares the loaded value in the register to a correct fuseword value and, if there is a match, generates the fuse sensing initiation signal for application to the fuse sensor circuit. A second comparison circuit compares the loaded value in the register to a correct password value and, if there is a match, generates a pass control signal authorizing operation of the circuit.

In an embodiment, a circuit comprises: a trimming fuse; a fuse sensor circuit connected to the trimming fuse which operates in response to a fuse sensing initiation signal to initiate sensing of a state of the trimming fuse and generate an output indicative of the sensed state; a latch circuit including multiple latch locations to redundantly latch the output indicative of the sensed state; and a polling circuit coupled to the multiple latch location, the polling circuit operating to determine a majority logic state in the latch locations and output that majority logic state as a fuse state output indicative of the sensed state of the fuse. A register is loadable with a value. A comparison circuit compares the loaded value in the register to a correct fuseword value and, if there is a match, generates the fuse sensing initiation signal for application to the fuse sensor circuit.

### BRIEF DESCRIPTION OF THE DRAWINGS

Other objectives, features and advantages of the invention will become apparent upon reading the following description, presented solely by way of non-limiting example and with reference to the appended drawings, in which:

FIG. 1 is a diagram of a fuse sensing initiation comparator circuit which generates a FUSE control signal;

FIG. 2 shows circuitry for logically combining a power-on-reset signal and chip enable signal with the FUSE control signal to generate a FUSE PULSE signal;

FIG. 3 is a block diagram of a circuit for sensing and latching a fuse state in response to the FUSE PULSE signal;

FIG. 4 is a block diagram of a fuse sense circuit;

FIG. 5 shows circuitry for a fuse sense control circuit in the fuse sense circuit of FIG. 4;

FIG. 6 shows circuitry for a fuse sensor in the fuse sense circuit of FIG. 4;

FIG. 7 is a block diagram of an alternate embodiment for the fuse sense circuit;

FIG. 8 is a diagram of a redundant latching circuit;

FIG. 9 is a diagram of an alternate embodiment for the redundant latching circuit; and

FIG. 10 is a diagram of a latch control circuit.

### DETAILED DESCRIPTION OF THE DRAWINGS

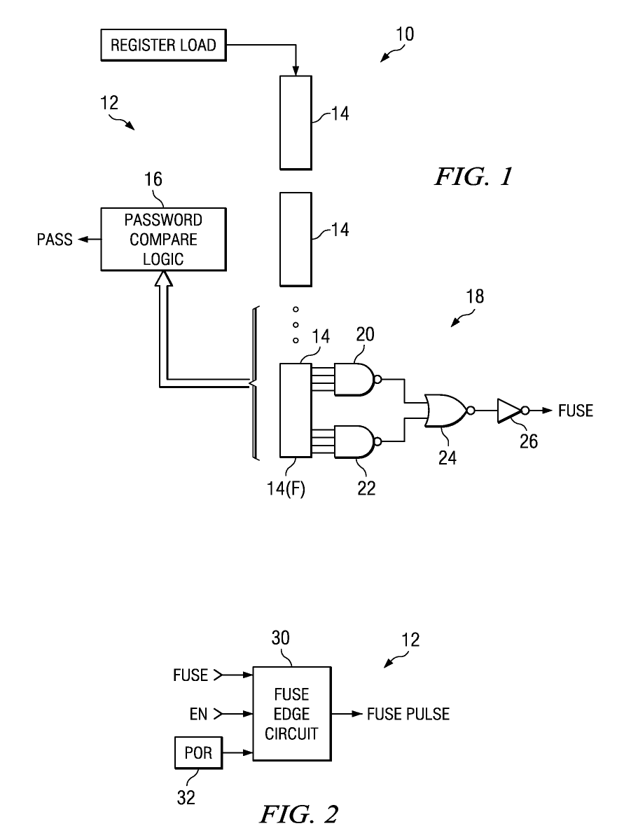

Reference is now made to FIG. 1 wherein there is shown a diagram of a fuse sensing initiation comparator circuit 10. An integrated circuit 12 may include a number of multi-bit registers 14 for storing data received through a register load functionality (either serial or parallel in format). These registers 14 can be used on the integrated circuit for any one of a number of purposes known to those skilled in the art. The data in the registers can be processed by the circuitry of the integrated circuit 12 in connection with performing and/or controlling a number of circuit operations.

For example, the registers 14 can receive a password through the register load functionality and store that password in the bits of the registers. A password comparison circuit 16 logically combines the password data stored in one or more of the registers 14, and if the stored password data matches a pre-assigned valid password value (which may be hardwire programmed into the integrated circuit), an active PASS control signal is generated at the output of circuit 16. This active PASS control signal can then be used within the integrated circuit 12 to permit certain functional operations to be performed, wherein performance is conditioned on the loading of the correct password into the registers 14. For example, the active PASS control signal may enable certain other circuitry on the integrated circuit, or enable the loading of data into other registers, or enable an output to be generated or an input to be received.

Specific reference is now made to a portion of the registers 14, and more particularly to just one eight bit register 14(F). Register 14(F) in this illustrated embodiment is a dual function register. In normal/regular operation of the integrated circuit 12, register 14(F) is just one of possibly many registers 14 in the integrated circuit which receive the password data loaded through the register load functionality. The register 14(F) in its second/test mode of operation can receive a fuseword through the register load functionality and store that fuseword in the bits of register 14(f). It will be recognized that the fuseword will have a value different than the bits of the password value for register 14(F). A fuseword comparison circuit 18 logically combines the fuseword data stored in register 14(F), and if that data matches a pre-assigned fuseword value (again, typically hardwire programmed into the integrated circuit), an active FUSE control signal is generated. This active FUSE control signal is used within the integrated circuit 12 to initiate fuse sensing operations in a manner to be discussed.

In a specific example, the eight bits of register 14(F) are processed by the password comparison logic 16 which includes a pair of four input NAND gates 20 and 22, a two input NOR gate 24 and a NOT gate 26. The inputs of the NAND gates 20 and 22 receive individual ones of the eight bits of data stored in register 14(F). NAND gate 20 logically combines the first four bits of register 14(F), while NAND gate 22 logically combines the last four bits of register 14(F). The outputs of NAND gates 20 and 22 are logically combined by NOR gate 24. The output of NOR gate 24 is logically inverted by NOT gate 26 to generate the FUSE signal. In the illustrated exemplary circuit logic 16, if register 14(F) is loaded with a fuse word of all logic “1” (i.e., 11111111), then the circuit produces an active FUSE control signal at logic “0” (i.e., active low). Any other data values loaded into the register 14(F), including for example the bits from the correct value of the password, would result in the generation of an inactive FUSE control signal at logic “1”. The configuration of the NAND gates 20 and 22 essentially hardwire sets the value of the correct fuseword for initiating fuse sensing. One skilled in the art knows how to configure the NAND gates 20 and 22 to hardwire program a different fuseword value. While an 8-bit word is shown being used for the fuseword, the fuseword can have more or less bits (including as few as one bit) as desired. Other types of circuitry known to those skilled in the art to be suitable for performing the password value comparison operation can be used in place of the illustrated combinational logic circuit.

Although FIG. 1 shows dual use of register 14(F), it will be understood that the register 14(F) used in connection with the fuseword comparison circuit 18 need not be shared with any registers 14 used in connection with the password comparison circuit 16 or any other operation. The functionalities for password comparison and fuseword comparison can be separately implemented on the integrated circuit 12 if desired. Additionally, certain integrated circuits 12 may not have a need for password control, and thus only the register 14(F) and fuseword comparison circuit 18 need be implemented. However, when both password comparison and fuse initialization are required, there is an advantage in terms of integrated circuit size and configuration to sharing use of the registers 14 in connection with both functionalities.

It will be noted, in the context of the illustrated circuitry, that following the loading of register 14(F) with the fuseword which causes initialization of the fuse sensing operation, the password can then be loaded in the registers 14, or alternatively the registers 14 can then be loaded with some other “safe” value to prevent an inadvertent actuation of circuitry within the integrated circuit.

With the illustrated implementation, fuse sensing in this integrated circuit 12 is initiated by the loading of the correct fuseword in register 14(F). This is distinct from prior art implementations which utilized, for example, power-on-reset (POR) circuitry as the trigger to initiate fuse sensing operations. This prior art POR solution is problematic because fuse sensing would be initiated on each POR event, and this could result in excessive and unnecessary initiations which drain power from the integrated circuit power supply (such as a battery).

This initiation triggering distinction over the prior art is emphasized by reference to FIG. 2 which shows circuitry for logically combining a power-on-reset signal and chip enable signal for the integrated circuit 12 with the FUSE control signal. A combinational logic circuit of any suitable design is used for a fuse edge circuit 30 which logically combines the FUSE control signal output from FIG. 1 (active low when the fuseword is stored in register 14(F)) with a power-on-reset (POR) signal received from a power-on-reset circuit 32 and a chip enable (EN) signal. When each of the FUSE, POR and EN signals are “active,” then the fuse edge circuit 30 generates and outputs a FUSE PULSE signal. This FUSE PULSE signal can take on any suitable format, but in a preferred implementation is a single edge or pulse clocked output signal indicating that fuse sensing operations should be initiated on the integrated circuit 12.

It will, of course, be understood that the implementation of FIG. 2 is exemplary in nature only. The point of fuse edge circuit 30 is to generate the FUSE PULSE signal only when the FUSE control signal output from FIG. 1 is active (as a result of the loading of the correct fuseword in the register). Consideration of one or the other or both of the POR and EN signals is not necessarily required, and in an embodiment of the fuse sensing initiation circuit these signals are either not considered in triggering FUSE PULSE signal generation (i.e., the FUSE control signal alone acts as the trigger), or alternatively could be replaced with other signals which are considered in triggering FUSE PULSE signal generation. For example, fuse edge circuit 30 could in an alternative embodiment comprise a one-shot pulse generator circuit responsive to the active FUSE control signal. In an preferred implementation, the EN signal an external chip enable clock signal and the edge circuit 30 logically combines this signal with the FUSE signal to generate the FUSE PULSE signal. Thus, one would write to register 14(F) in one clock cycle and then in a later clock cycle the EN signal changes state to cause the FUSE PULSE signal to be generated by the edge circuit 30.

Thus, what fuse edge circuit 30 accomplishes is the triggering of fuse sensing operation based conditionally on the loading of the proper fuseword in the register 14(F). In other words, the loading of the proper fuseword in the register 14(F) is the condition precedent to initiating fuse sensing operations. This is distinct from prior art fuse sensing circuitry which was initiated for operation based on the occurrence of the POR event. By using the proper fuseword as the condition precedent to fuse sensing initiation, one can effectively preclude instances of unwanted and energy wasting fuse sensing operations.

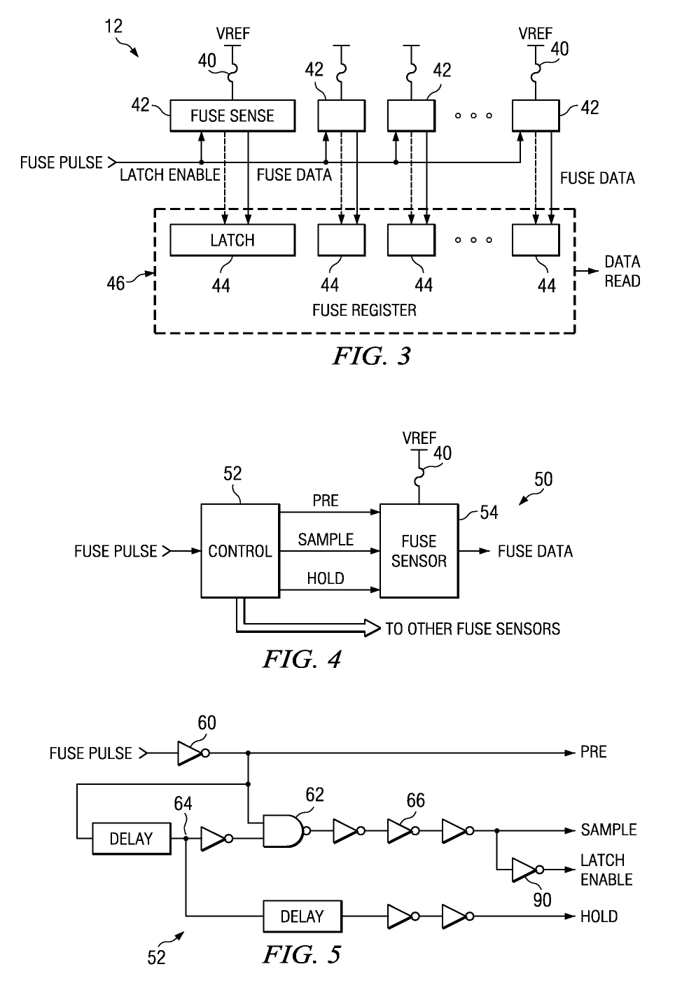

Reference is now made to FIG. 3 wherein there is shown a block diagram of a circuit for sensing and latching a fuse state in response to the FUSE PULSE signal. The integrated circuit 12 includes a plurality of trimming fuses 40 each connected to a reference voltage Vref. This reference voltage Vref can be either a positive voltage, a negative voltage or a ground voltage as is desired by the nature of the fuse configuration. Also connected to each fuse 40 is a fuse sense circuit 42. Each fuse sense circuit 42 includes an input which receives the FUSE PULSE signal output from fuse edge circuit 30. As discussed above, in a preferred implementation this FUSE PULSE signal is output when the condition precedent of loading the proper fuseword in register 14(F) is satisfied. In response to receipt of the FUSE PULSE signal, each fuse sense circuit 42 senses the condition of the fuse 40 connected thereto (i.e., is the fuse blown or not blown). A FUSE DATA signal having a logic state indicative of the sensed fuse state is then output from each fuse sense circuit 42 and received by an associated latch circuit 44 where the data indicative of fuse state is stored and latched. The plurality of latch circuits 44 associated with the plurality of fuses 40 may be included in a register 46. The data from the latches 44 (or register 46) may be read out using a conventional serial or parallel register read operation and used in any number of ways and for purposes known to those skilled in the art.

The latch circuit 44 may take on any known circuit form (including, for example, a simple D-type latch or a more robust latch configuration). In a preferred implementation, the latch circuit 44 has a more robust latching configuration such as that shown in U.S. Pat. No. 5,570,313, the disclosure of which is incorporated herein by reference.

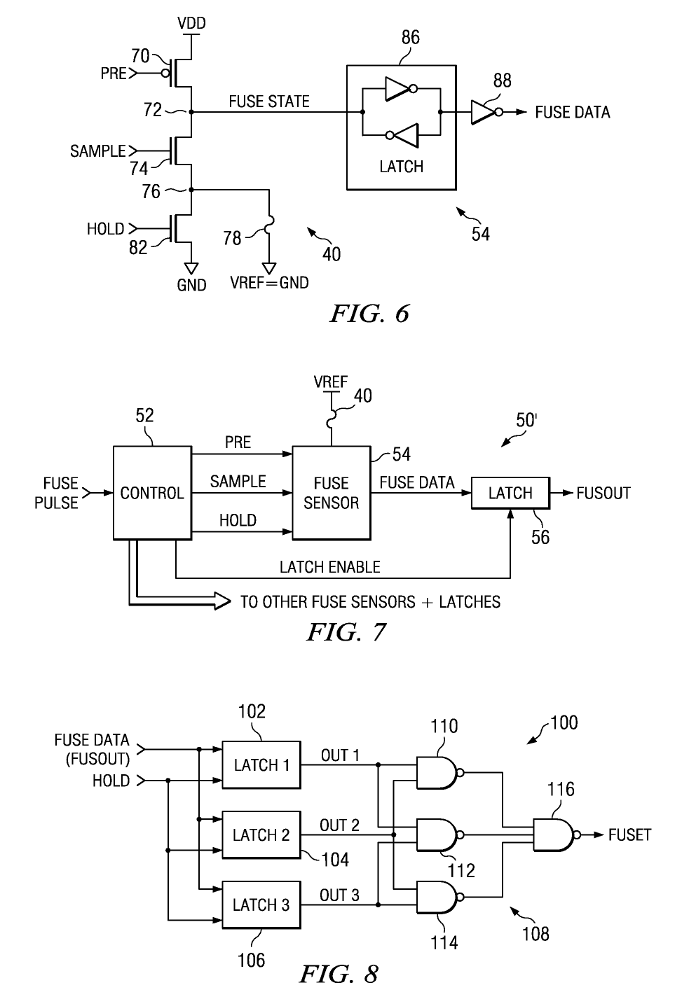

Reference is now made to FIG. 4 wherein there is shown a block diagram of a fuse sense circuit 50 (such as may be used in a given implementation for the fuse sense circuit 42 of FIG. 3). The fuse sense circuit 50 includes a fuse sense control circuit 52 and a fuse sensor 54. The circuitry for the fuse sense control circuit 52 is shown in FIG. 5. The circuitry for the fuse sensor 54 is shown in FIG. 6.

It will be understood that the fuse sense control circuit 52 control output(s) can be shared among a plurality of a fuse sensors 54. Thus, only one fuse sense control circuit 52 is needed for use with many fuse sensors 54, and the outputs of the fuse sense control circuit 52 are passed to each included fuse sensor 54. This feature is emphasized in FIG. 4 by the presence of an output arrow (control signals) pointing to other fuse sensors.

The fuse sense control circuit 52 (see, FIG. 5) responds to the FUSE PULSE signal and generates a plurality of control signals having a certain timing relationship. The circuit 52 comprises an inverter 60 which receives the FUSE PULSE signal and generates its logical complement as a first control signal referred to as a precharge (PRE) signal. The output of inverter 60 is applied to one input of a NAND gate 62. The other input of the NAND gate 62 receives a delayed and logically inverted (reference 64) version of the PRE signal output from the inverter 60. The output of the NAND gate 62 is buffered through a set of inverters 66 to generate a second control signal referred to as a sampling (SAMPLE) signal. A delayed and buffered version of the signal applied to the second input of NAND gate 62 (at reference 64) generates a third control signal referred to as a hold (HOLD) signal. Thus, the fuse sense control circuit 52 generates a set of timing control signals (PRE, SAMPLE and HOLD). The use of these timing signals will be better understood in connection with the operation of the fuse sensor 54.

The fuse sensor 54 (see, FIG. 6) comprises a p-channel transistor 70 with its source connected to Vdd and its drain connected to node 72 where a signal FUSE STATE is generated. The gate of transistor 70 receives the precharge signal PRE output from the fuse sense control circuit 52. An n-channel transistor 74 has its drain connected to node 72 and its source connected to node 76 which is a node connected to the fuse 40 that is being sensed by circuit 54. The gate of transistor 74 receives the sampling signal SAMPLE output from the fuse sense control circuit 52. The fuse 40 comprises a fuse element 78 connected between node 76 and the reference voltage Vref, which in this implementation is ground GND. Another n-channel transistor 82 in the circuit 54 has its drain connected to node 76 and its source connected to ground. The gate of transistor 82 receives the hold signal HOLD output from the fuse sense control circuit 52. The FUSE STATE signal output from node 72 is applied to a simple latch circuit 86 formed by a pair of cross-coupled CMOS inverters. The output of latch 86 is logically inverted by inverter circuit 88 to produce the FUSE DATA signal.

The fuse sensor 54 operates responsive to the set of timing control signals (PRE, SAMPLE and HOLD) as follows. In response to an edge on the received FUSE PULSE signal, the fuse sense control circuit 52 first generates a logic low precharge signal (PRE) pulse through inverter 60 which turns on transistor 70 bringing node 72 to Vdd. This precharges the output of the latch 86 to a first state (logic low). Inverter 88 inverts this logic low signal to generate a logic high FUSE DATA signal. The signal PRE pulse then goes high to turn off transistor 70. The delay circuit with NAND gate 62 delays the PRE signal pulse to allow the fuse sense control circuit 52 to subsequently generate a logic high sampling signal SAMPLE pulse which turns on transistor 74. This connects node 72 to node 76, wherein node 76 is connected to the fuse 40. The fuse sensing operation is now being performed. If the fuse 78 is not blown, node 76 is at ground and the transistor 74 pulls down the FUSE STATE signal, and the input to the latch 86, also to ground. This will result in a switching of the output of the latch 86 to a second state (logic high). Inverter 88 inverts this signal to generate a logic low FUSE DATA signal (wherein logic low indicates that the fuse has not been blown). Conversely, if the fuse is blown, then node 76 is not grounded and the FUSE STATE signal cannot cause a flip in the stored state of the latch 86. The latch thus remains in the original precharged first state (logic low). Inverter 88 inverts this signal to generate a logic high FUSE DATA signal (wherein logic high indicates that the fuse is blown). The SAMPLE signal pulse then goes low to turn off transistor 74 and ends the fuse sensing operation. At this point in time, the FUSE DATA signal (high or low) is latched by the latch 44 (FIG. 3). The delay circuit connected to the second input of the NAND gate 62 adds a further delay to the PRE signal pulse to allow the fuse sense control circuit 52 to generate a logic high hold signal HOLD pulse which turns on transistor 82 connecting node 76 to ground and shunting across the fuse element 78 to dissipate any charge stored at node 76. The HOLD pulse remains highs at end of sensing to permanently short node 76 to ground. The end result is a holding of the state of the latch 86 to have an output value indicative of the sensed state of the fuse 40.

The fuse sensors 54 are controlled by the timing signals output from one fuse sense control circuit 52 in response to the received FUSE PULSE signal so as to effectuate a simultaneous individual sensing of each fuse 40, followed by latching of the fuse state in latch 86 and output of the individual FUSE DATA signals representative of the fuse state. It will, of course be understood that such a simultaneous sensing operation need not necessarily be performed. Serial sensing or sensing of small groups of fuses simultaneously is another option for implementation. The end result, however, no matter which technique is used, is that a separate FUSE DATA signal is generated for each fuse, and that this signal indicates the sensed blown/not blown state of the fuse. This FUSE DATA signal is then stored in latch 44 (FIG. 3).

An advantage of the disclosed circuit is low power consumption at the end of the sensing operation. The reason for this low power consumption is that at the end of the sense operation, the SAMPLE signal goes low which turns off transistor 74 (FIG. 6), thus effectively disconnecting nodes 72 and 76 with a very high impedance. The circuit accordingly reduces power consumption following sensing by orders of magnitude in comparison to prior art circuits.

Reference is now made to FIG. 7 wherein there is shown a block diagram of an alternate embodiment for the fuse sense circuit 50′ (such as may be used in a given implementation for the fuse sense circuit 42 of FIG. 3). The fuse sense circuit 50′ includes a fuse sense control circuit 52, a fuse sensor 54 and a robust latch 56. The circuitry for the fuse sense control circuit 52 is shown in FIG. 5. The circuitry for the fuse sensor 54 is shown in FIG. 6. It will be understood that fuse sense control circuit 52 can be shared among a plurality of a fuse sensors 54 as discussed above in connection with FIG. 4. Thus, only one fuse sense control circuit 52 is needed for use with many fuse sensors 54. The robust latch 56 is of the D-type with a robust configuration as is shown in U.S. Pat. No. 5,570,313, the disclosure of which is incorporated herein by reference. FIG. 5 shows an inverter 90 which logically inverts the SAMPLE signal pulse to generate a fourth time control signal referred to as a latch enable signal (LATCH ENABLE) pulse. This pulse is applied to each robust latch 56 associated with a fuse sensor 54 circuit following initiation of sampling to sense the fuse state. A first data input of the robust latch 56 receives the FUSE DATA output of inverter 88 (FIG. 5). A second control input of the robust latch 56 receives the LATCH ENABLE signal pulse. In response to the LATCH ENABLE signal pulse, the robust latch 56 functions to store and latch the logic state of the output of inverter 88 comprising the FUSE DATA signal. It will be noted that in this implementation, the robust latch 56 outputs a fuse out signal (FUSOUT) indicative of fuse state.

It will be recognized that the latch 56 of FIG. 7 can be the same latch as the latch 44 shown in FIG. 3. In such a configuration, the latching operation of latch 44 is controlled by an additional control signal output of the fuse sense circuit 42. Thus, in addition to outputting the FUSE DATA signal (for example from inverter 88 in FIG. 6), the fuse sense circuit 42 would also output the LATCH ENABLE signal pulse (for example from control circuit 52 of FIG. 5) so as to cause the received FUSE DATA signal to be latched by the robust latch 44. This alternative implementation is illustrated by the presence of a dotted line LATCH ENABLE signal in FIG. 3.

Reference is now made to FIG. 8 wherein there is shown a diagram of a redundant latching circuit 100. The redundant latching circuit 100 receives as its inputs the FUSE DATA or FUSOUT output of the fuse sense circuit 50 (or 50′) and a latch control signal which in a preferred implementation is the HOLD signal pulse output from fuse sense control circuit 52. The latch control signal can alternatively be derived from the LATCH ENABLE signal (or its predecessor signals as in FIG. 5), and thus the circuit 100 could comprise the latch 44 of FIG. 3 or alternatively the latch 56 of FIG. 7. The circuit 100 includes three robust latch circuits 102, 104 and 106 of the D-type (implemented in the manner shown in U.S. Pat. No. 5,570,313, the disclosure of which is incorporated herein by reference). The data to be latched is the FUSE DATA output (from FIGS. 6 or 7). The latching control signal is received from the HOLD signal pulse output (see, FIG. 5). The latches 102, 104 and 106 essentially redundantly latch the FUSE DATA (FUSOUT) output in separate physical locations.

A polling circuit 108 is connected to the output of the three robust latch circuits 102, 104 and 106. The polling circuit 108 includes three two input NAND gates 110, 112 and 114. NAND gate 110 receives OUT1 and OUT2 from the first and second robust latches 102 and 104. NAND gate 112 receives OUT1 and OUT3 from the first and third robust latches 102 and 106. NAND gate 114 receives OUT2 and OUT3 from the second and third robust latches 104 and 106. The outputs of NAND gates 110, 112 and 114 are received by three input NAND gate 116 which outputs a fuse true signal (FUSET).

The polling circuit 108 essentially polls the outputs OUT1, OUT2 and OUT3 of the three robust latch circuits 102, 104 and 106 and sets the value of the fuse true signal FUSET using a two-out-of-three combinational logic circuit. The fuse true signal FUSET will have a state that is the same as the majority logic state present in the OUT1, OUT2 and OUT3 signals from the robust latches 102, 104 and 106. Thus, if two or three of the outputs OUT1, OUT2 and OUT3 are logic “1”, then fuse true signal FUSET will also be logic one (which in one implementation, for example, indicates that the sensed fuse is blown). Conversely, if two or three of the outputs OUT1, OUT2 and OUT3 are logic “0”, then fuse true signal FUSET will also be logic zero (which in one implementation, for example, indicates that the sensed fuse is not blown).

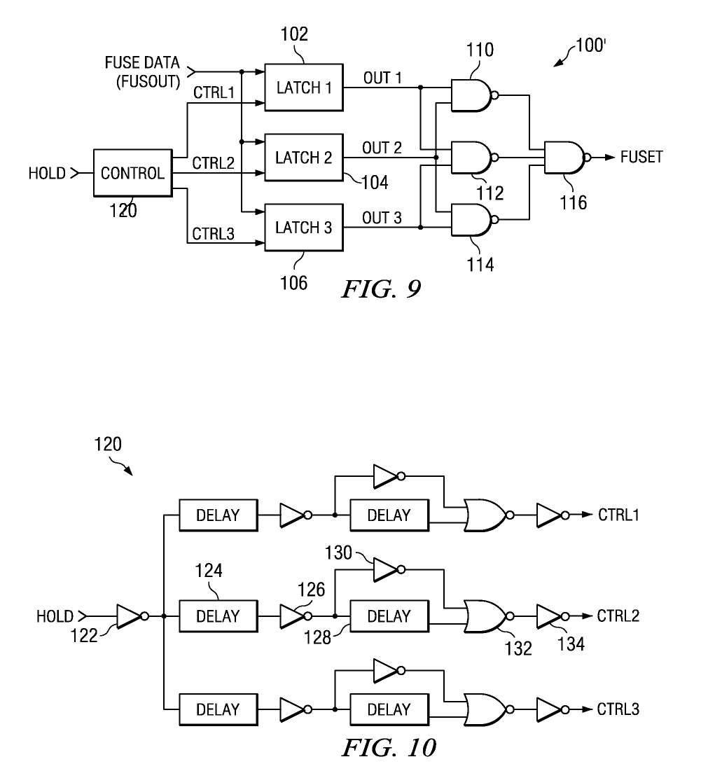

Reference is now made to FIG. 9 wherein there is shown a diagram of an alternate embodiment for the redundant latching circuit 100′. The circuit 100′ further includes a latch control circuit 120 which receives the latching control signal from the HOLD signal pulse output of fuse sense control circuit 52. The latch control circuit 120 includes circuits for separately generating three latch control signals CTRL1, CTRL2 and CTRL3 from the received HOLD signal (in a logic follower configuration). An exemplary implementation of this CTRL1, CTRL2 and CTRL3 generating circuitry is shown in FIG. 10. The remainder of the circuit 100′ is identical to that shown for circuit 100 in FIG. 8, and will not be further explained. The use of separate latch control signals CTRL1, CTRL2 and CTRL3 derived from the HOLD signal pulse provides an added level of security in connection with the signal processing of the FUSE DATA signal.

As shown in FIG. 10, the latch control circuit 120 includes three branch circuits, each branch circuit have a same configuration, for generating the CTRL1, CTRL2 and CTRL3 latch control signals. A buffering inverter 122 receives the HOLD signal and generates an inverted control signal applied to each branch. In each branch, the buffered control signal first passes through a delay circuit 124. The output of the delay circuit then passes through an inverter 126. The output of the inverter is applied to the input of a delay 128 and the input of a bypass inverter 130. The outputs of the delay and bypass inverter are logically combined by a NOR gate 132. The output of the NOR gate is logically inverted 134 to generate the control signal (CTRL1, CTRL2 or CTRL3) which has the same logic state as the received HOLD signal. In the event of a circuit failure in any one of the branches, the remaining branches will generate appropriate control signals and the two-out-of-three combinational logic polling circuit 108 in FIGS. 8 or 9 will still be able to generate a FUSET output indicative of sensed fuse state.

The redundancy circuitry provided in FIGS. 8-10 is an improvement over the latch circuitry of FIGS. 3 and 7. This circuitry addresses issues with respect to reducing the potential for data loss due to temporary circuit disturbances. These losses occur, for example, as a result of the circuit being hit by alpha, neutron or proton particles. The resulting error is a soft error and the extent of data loss is designated as a soft error rate (SER).

These soft errors differ from a hard circuit defect because the circuits are not damaged and can still be operated properly after the signals or stored data are reestablished following the error event or disturbance. As known to those skilled in the art, the circuitry most vulnerable to these disturbances are storage elements, memory cells, latches or registers.

The triple redundant fuse status storage latches 102-106 and polling circuit 108 of FIG. 8 address and overcome these soft errors. If the data in one latch is corrupted by the disturbance, the remaining latches will maintain correct data through the polling circuit. While the individual robust latch circuits referenced herein were specially designed to make it difficult for particles (or other disturbances) to corrupt the latched data, three such latches 102-106 are preferably used and these latches are placed far enough apart from each other on the integrated circuit so that a particle hit could not corrupt data in more than one latch.

Notwithstanding this level of protection, it is to be noted that all three latches 102-106 in the FIG. 8 design are fed by one non-robust latch (see, latch 86 of FIG. 6). If a disturbance occurred in both of these areas then a possibility exists for the data stored by all three redundant robust latches to be corrupted. To further enhance the robustness of the circuit design, FIG. 7 shows the addition of an additional robust latch 56 added between the non-robust latch 86 and the triple robust latches 102-106 of FIG. 8. This provides an additional level of improvement in connection with the protection of the data path.

It is also noted that all three robust latches in FIG. 8 are controlled by one latch enable signal (HOLD). The circuit design of FIGS. 9-10 provides duplicate latch control circuits 120 to eliminate the chance that a disturbance of any one latch control signal CTRL1/CTRL2/CTRL3 would affect all the operability of all three redundant latches 102-106. Thus, each redundant latch has its own latch control signal which improves the latch enable path.

The registers 14 of FIG. 1 are preferably made up of robust latches as described herein, with those latches arranged serially to form a flip-flop type of register.

The protection circuitry described above will contribute to reducing the SER to zero for alpha particles and to near zero for other particles.

Although preferred embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A circuit, comprising:
a trimming fuse;
a fuse sensor circuit connected to the trimming fuse which operates in response to a fuse sensing initiation signal to initiate sensing of a state of the trimming fuse and generate an output indicative of the sensed state;
a data register which is loadable with a value; and
a comparison circuit which compares the loaded value in the register to a correct fuseword value and, if there is a match, generates the fuse sensing initiation signal for application to the fuse sensor circuit.

2. The circuit of claim 1 wherein the circuit is an integrated circuit.

3. The circuit of claim 1 wherein the comparison circuit is a combinational logic circuit.

4. The circuit of claim 1 further comprising a second comparison circuit which compares the loaded value in the register to a correct password value and, if there is a match, generates a pass control signal authorizing operation of the circuit.

5. The circuit of claim 1 further comprising a latch circuit for latching the output from the fuse sensor circuit indicative of the sensed state of the fuse.

6. The circuit of claim 5 wherein the latch circuit includes a latch control input, the fuse sensor circuit further generating a latch control signal for application to the latch control input when the output indicative of the sensed state of the fuse is generated.

7. The circuit of claim 5 wherein the latch circuit comprises a redundant latch including a plurality of individual latches which each latch the output from the fuse sensor circuit indicative of the sensed state of the fuse.

8. The circuit of claim 7 further comprising a polling circuit coupled to outputs of the plurality of individual latches, the polling circuit operating to determine a majority logic state of the latched outputs from the fuse sensor circuit indicative of the sensed state of the fuse and output that majority logic state as a fuse state output.

9. The circuit of claim 8 wherein the polling circuit comprises a combinational logic circuit.

10. The circuit of claim 7 wherein each of the plurality of individual latches includes a latch control input, the fuse sensor circuit further generating a latch control signal for application to each latch control input when the output indicative of the sensed state of the fuse is generated.

11. The circuit of claim 7 wherein each of the plurality of individual latches includes a latch control input, further comprising a latch control circuit which responds to an indication received from the fuse sensor circuit that the output indicative of the sensed state of the fuse is available and independently generates a separate latch control signal for application to each latch control input.

12. The circuit of claim 1 wherein the fuse sensing initiation signal is a pulsed signal, the comparison circuit further comprising a pulse generator circuit responsive to the match between the loaded value in the register and the correct fuseword.

13. A method, comprising:
comparing a loaded fuseword value to a correct fuseword value;
if there is a match, generating a fuse sensing initiation signal; and
performing a fuse sensing operation in response to the generated fuse sensing initiation signal to sense a state of a trimming fuse and generate an output indicative of the sensed state.

14. The method of claim 13 further comprising latching the output indicative of the sensed state of the fuse.

15. The method of claim 14 wherein latching comprises redundantly latching the output indicative of the sensed state of the fuse in a plurality of locations.

16. The method of claim 15 further comprising:
polling the plurality of locations to determine a majority logic state of the latched outputs indicative of the sensed state of the fuse; and
outputting that majority logic state as a fuse state output.

17. A circuit, comprises:
a trimming fuse;
a fuse sensor circuit connected to the trimming fuse which operates in response to a fuse sensing initiation signal to initiate sensing of a state of the trimming fuse and generate an output indicative of the sensed state;
a register which is loadable with a value;
a first comparison circuit which compares the loaded value in the register to a correct fuseword value and, if there is a match, generates the fuse sensing initiation signal for application to the fuse sensor circuit; and
a second comparison circuit which compares the loaded value in the register to a correct password value and, if there is a match, generates a pass control signal authorizing operation of the circuit.

18. The circuit of claim 17 wherein the circuit is an integrated circuit.

19. The circuit of claim 17 further comprising a latch circuit for latching the output from the fuse sensor circuit indicative of the sensed state of the fuse.

20. The circuit of claim 19 wherein the latch circuit comprises a redundant latch including a plurality of individual latches which each latch the output from the fuse sensor circuit indicative of the sensed state of the fuse.

21. The circuit of claim 20 further comprising a polling circuit coupled to outputs of the plurality of individual latches, the polling circuit operating to determine a majority logic state of the latched outputs from the fuse sensor circuit indicative of the sensed state of the fuse and output that majority logic state as a fuse state output.

22. The circuit of claim 17 wherein the fuse sensing initiation signal is a pulsed signal, the first comparison circuit further comprising a pulse generator circuit responsive to the match between the loaded value in the register and the correct fuseword.

23. A circuit, comprising:
a trimming fuse;
a fuse sensor circuit connected to the trimming fuse which operates in response to a fuse sensing initiation signal to initiate sensing of a state of the trimming fuse and generate an output indicative of the sensed state;
a latch circuit including multiple latch locations to redundantly latch the output indicative of the sensed state;
a polling circuit coupled to the multiple latch location, the polling circuit operating to determine a majority logic state in the latch locations and output that majority logic state as a fuse state output indicative of the sensed state of the fuse;
a register which is loadable with a value; and
a comparison circuit which compares the loaded value in the register to a correct fuseword value and, if there is a match, generates the fuse sensing initiation signal for application to the fuse sensor circuit.

24. The circuit of claim 23 wherein the circuit is an integrated circuit.

25. The circuit of claim 23 wherein the fuse sensing initiation signal is a pulsed signal, the comparison circuit further comprising a pulse generator circuit responsive to the match between the loaded value in the register and the correct fuseword.
